(19) United States
(12) Patent Application Publication
(10) Pub. No.: US 2006/0076466 A1
(43) Pub. Date: Apr. 13, 2006

(54) SUPPORT FOR FIXING AN ELECTRONIC MODULE TO AN AUTOMOBILE BATTERY

(75) Inventor: Josep Serra, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/711,928

(22) Filed: Oct. 13, 2004

(51) Int. Cl. F16M 11/00

(52) U.S. Cl. 248/200

(57) ABSTRACT

A mounting support device is shown for mounting an electronic module to an automobile battery and positioning the electronic module in the plane of the battery.

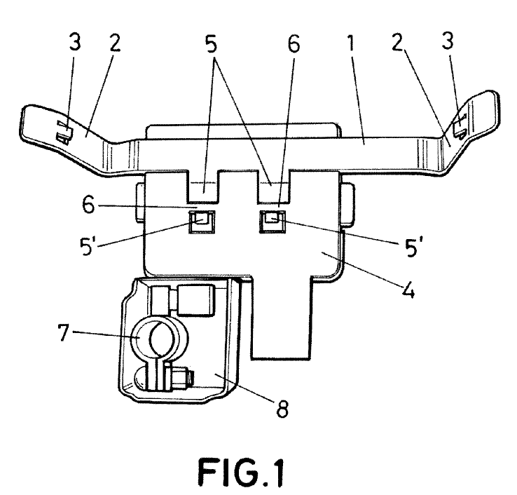

### OBJECT OF THE INVENTION

The present invention refers to a support for fixing an electronic module to an automobile battery, a support having features such that they allow for fixing the electronic module to the battery without needing screws or additional elements, but allowing for maintaining the contact of the module with the plane of the battery.

### BACKGROUND OF THE INVENTION

As is known, in the automobile sector, it is sometimes necessary to install an electronic module at the battery output which, as is evident, will be connected to the corresponding positive terminal of the battery, such that this electronic module must be perfectly shielded against water, since on many occasions when it rains, water can be entrained by the wheels, reaching the area in which the battery is located.

Therefore, it is necessary for the module to be perfectly shielded against water, such that the corresponding electronic circuit or circuits of the modules are housed in a box or casing which must be perfectly watertight for preventing the circuits from becoming damaged.

However, until now the most common manner of carrying out the fixing of the electronic module to the battery has been by means of screws, which requires perforating the casing of the module, implying a risk that, over time, water will seep through the holes.

### DESCRIPTION OF THE INVENTION

The support that is proposed has been designed to solve the aforementioned drawbacks based on a simple but highly effective solution, to which end it has been provided that the fixing is carried out without screws of any type and, therefore, free of holes through which, and over time, water or moisture could enter into the circuits of the module.

More specifically, the support of the invention is constituted of a U-shaped profile, the width of which will correspond to that of the battery, so that the latter can be positioned on said U-shaped profile or support, the battery being held with regard to the support resulting from the fact that the support has on its side branches and in correspondence with their inner side, several pins coupling by pressure, fitting into recesses arranged for that purpose on the body of the battery.

A type of fork projects from the middle branch of the U-shaped support or profile for the fixing of the electronic module, to which end the latter has on its corresponding casing a pair of recesses forming respective bridges, without communicating with the interior of the module, through which bridges and under them the branches of the fork are passed, the branches having a discontinuous or warped profile in order to be forced to become elastically deformed and reach the final assembly position, the module being perfectly fixed to the support by means of respective projections by way of locking hooks locking said branches of the fork.

Likewise, a type of inverted shield has been provided which is similar to that which standard battery terminals incorporate, in which a clamp or bushing is located for connecting the corresponding electronic circuit existing in the module to the battery terminal, therefore it will have to be longer than the standard one in order to be able to first assemble the classic and standard bushing of a battery and then the bushing or clamp for connecting the electronic module to said battery.

It can thus be seen that the fixing of the module to the battery is carried out by means of the support described, but without needing screws or additional elements, with a water-tightness of the internal circuits of said module, and at the same time an effective fixing of the module itself.

### DESCRIPTION OF THE DRAWINGS

To complement the description being made and for the purpose of helping to better understand the features of the invention, according to a preferred practical embodiment example thereof, a single sheet of drawings is attached as an integral part of said description which shows, with an illustrative and non-limiting character, a perspective view of the support of the invention to which the electronic module will be fixed so that, through said support, said electronic module is fixed to the corresponding battery of an automotive vehicle.

### PREFERRED EMBODIMENT OF THE INVENTION

In view of the indicated figure, it can be observed how the support of the invention is constituted by means of a U-shaped profile (1) by way of a flat bar, the side branches (2) of which have on their inner side respective pins (3), such that the length or width of said support (1 ) will correspond to the width of the battery in order for the latter to be positioned inside the support and fixed thereto through the positioning and locking of such pins (3) of the side branches (2) of the support (1 ) into respective recesses arranged for that purpose on the side surface of the body of the battery.

The fixing of the corresponding electronic module (4) to the battery is carried out by means of the support (1 ) itself, to which end the intermediate branch of the latter has a type of fork (5) the branches of which pass through and under the bridges (6) arranged as a result of recesses made for that purpose on the body or casing of the module (4), without communicating with the interior of the latter, such that the passage of the branches of the fork (5) through these recesses, under the bridges (6), by virtue of a discontinuous or warped profile of such branches of the fork (5), the latter are forced to become elastically deformed until reaching the final assembly position, the module (4) being perfectly stabilized and fixed with regard to the support (1), the anchoring being arranged by means of corresponding projections by way of claws (5′) provided for that purpose on the branches of said fork (5).

As a complement of that set forth above, it has been provided that the connection of the electronic circuit of the module (4) to the corresponding battery, and specifically to the positive terminal thereof, is carried out by means of a bushing or clamp (7) provided on an inverted shield (8) similar to that of standard battery terminals, such that the connection of the module (4) with the corresponding battery terminal will be carried out through this clamp or bushing (7).

1. (previously canceled)

2. A support for fixing an electronic module to an automobile battery according to claim 4, wherein said pins of said intermediate pair of branches are claws locking behind bridges located within said corresponding recesses in said electronic module.

3. (previously canceled)

4. A support for fixing an electronic module to an automobile battery said support comprising:
a U-shaped profile having a first pair of branches, the first end of each of said first branches connected to a body and the second end of each of said first branches having a pin located near said second end, the length of said body being of sufficient length to span an automotive battery; and
an intermediate pair of branches each joined at a first end to said body between said pair of first branches, and orientated substantially ninety degrees to said pair of first branches, and the second end of each of said intermediate branches having a pin located near said second end for fixing an electronic module thereto;
said support is being fixed to said automobile battery by said pins of said first pair of branches locking into corresponding recesses located on said automobile battery and by being elastically deformed, and said electronic module is fixed to said support by said intermediate branches pins locking into corresponding recesses located on said electronic module.

5. A support having a battery terminal connector for fixing an electronic module to an automobile battery having a battery terminal said support comprising:
a U-shaped profile having a first pair of branches, the first end of each of said first branches connected to a body and the second end of each of said first branches having a pin located near said second end, the length of said body being of sufficient length to span an automotive battery; and
an intermediate pair of branches each joined at a first end to said body between said pair of first branches, and orientated substantially ninety degrees to said pair of first branches, and the second end of each of said intermediate branches having a pin located near said second end for fixing an electronic module thereto,
whereby said support is fixed to said automobile battery by said pins of said first pair of branches locking into corresponding recesses located on said automobile battery and by being elastically deformed, and said electronic module is fixed to said support by said intermediate branches pins locking into corresponding recesses located on said electronic module and to said battery terminal by means of said battery terminal connector comprising a clamp.
